(19) United States
(12) Patent Application Publication
(10) Pub. No.: US 2001/0023211 A1
(43) Pub. Date: Sep. 20, 2001

(54) Removable cover for bicycle chain and derailleurs

(76) Inventor: Melinda K. Bowman, Missoula, MT (US)

Correspondence Address: Richard C. Litman, LITMAN LAW OFFICES, LTD., P.O. Box 15035, Arlington, VA, 22215, US

(21) Appl. No.: 09/836,268

(22) Filed: Apr. 18, 2001

Related U.S. Application Data
(63) Continuation-in-part of application No. 09/526,877, filed on Mar. 16, 2000.
(60) Provisional application No. 60/125,548, filed on Mar. 22, 1999.

(51) Int. Cl. F16D 1/00

(52) U.S. Cl. 474/146

(57) ABSTRACT

A flexible, removable cover for a bicycle drive train including an elongated oval pouch dimensioned and configured to encase the front and rear sprocket and derailleurs, chain, and one pedal of a bicycle, pouch having a central flap folded over the central portion of the chain, VELCRO® patches strategically placed to hold and to secure portions of the cover about the front and rear sprockets, a zipper assembly to secure flap in place, and a wraparound seat post enclosure with a barrel-lock cinch which keeps water and debris from migrating down the post and onto the bicycle drive train. For tandem bicycles, an additional cover is provided for covering the chainstay drivetrain which is configured as an elongated pouch encasing a front and a rear pedal at their respective axles and covering the front and rear drive train sprockets and the intervening drive chain.

### CROSS-REFERENCE TO RELATED APPLICATIONS

This application is a Continuation-In-Part of Ser. No. 09/526,877, filed Mar. 16, 2000, which application claims the benefit of U.S. Provisional Patent Application Ser. No. 60/125,548, filed Mar. 22, 1999.

### BACKGROUND OF THE INVENTION

1. Field of the Invention

The present invention relates to covers and, more particularly, to a removable, flexible cover for the drive train of a bicycle (i.e., the chain, derailleurs and a pedal), and includes a cinch-tied cover about the base of the bicycle seat post.

2. Description of Related Art

Removable, flexible bicycle drive train covers are known. However, the prior art covers are somewhat bulky and difficult to put in place and remove, and lack the cinch-tied cover portion about the base of the bicycle seat post, as taught by the instant invention. The related art discussed below is adequately representative of developments in bicycle drive train covers.

U.S. Pat. No. 5,018,564 issued May 28, 1991 to Gregory V. Anglin et al. discloses a flexible cover for a bicycle drive train, including required front and rear slot openings for fitting the cover about the front and rear bicycle struts, respectively, VELCRO® closures for these openings, an elongated top opening with a Velcro closure, and a loop tied about spokes of the bicycle rear wheel to immobilize the rear wheel as the cover is placed about the bicycle drive train. The Anglin et al. cover lacks the single central flap and zipper closure flap of the present invention, includes a wheel-immobilizing loop tie not required in the present invention, and does not have the cinch-tied collar about the bicycle seat post base as provided by my invention.

U.S. Pat. No. Des. 348,860 issued Jul. 19, 1984 to John S. Reynolds shows a cinch tie pouch covering the drive train of a bicycle, but the interior of the drive train is left exposed when the pouch is in place. Thus, the cover cannot completely envelop the bicycle drive train; portions are left exposed to the elements. Similar pouches are seen in U.S. Pat. Nos. 4,623,416, issued Dec. 30, 1986 to Scott H. Zelenetz, and 5,520,584, issued May 28, 1996 to Thomas G. Brown. The pouches taught in these two patents have enclosed elastic cords for temporarily securing the cover or pouch in place over the bicycle drive train. Although these covers are relatively easily placed over the bicycle drive train, virtually all of the interiors of the derailleurs and chain remain exposed to the elements, and thus may be damaged by debris, rain, dirt, etc.

A chain guard which completely encloses the bicycle drive train is taught in U.S. Pat. No. 5,312,303 issued May 17, 1994 to Robert A. Hinschlager, but this guard is made of hard, shape-retaining plastic and is intended as a permanent chain guard, not a flexible, removable, temporary cover.

Less relevant but interesting covers encasing the entire bicycle are disclosed in the following patents. A bicycle cover including a cinch-tie and locking assembly, cover to bicycle, is taught in U.S. Pat. No. 5,372,169, issued Dec. 13, 1994 to Merritt Norton et al. Covers for completely encasing a bicycle mounted on an automobile carrier are seen in U.S. Pat. Nos. 3,968,913 issued Jul. 13, 1976 to Terrance O. Weed et al, and 4,009,744 issued Mar. 1, 1977 to John A. Joslyn. Other flexible bicycle covers of general interest are shown in U.S. Pat. Nos. 4,944,340 issued Jul. 31, 1990 to Rainey Tortorich and 5,282,502 issued Feb. 1, 1994 to Michael C. Ballard. U.K. Patent application No. GB 2 088 798 A to Carr shows a roll-up motorcycle cover for encapsulating the entire motorcycle, the cover being rolled up into a seat-mounted housing when not in use.

None of the above inventions and patents, taken either singly or in combination, is seen to describe the instant invention as claimed.

### SUMMARY OF THE INVENTION

The present invention is directed to a flexible, removable cover for a bicycle drive train (i.e., the derailleurs and chain) including an elongated oval pouch dimensioned and configured to encase the front and rear sprocket and derailleurs, and the chain of a bicycle, the pouch including a central flap folded over the central portion of the chain, VELCRO® patches strategically placed to hold portions of the cover about the sprockets, a zipper to secure the flap in place, and a wraparound seat post enclosure with a barrel-lock cinch, which keeps water and debris from migrating down the post and onto the bicycle drive train.

Accordingly, it is a principal object of the invention to provide a cover for use in protecting a bicycle chain.

It is a further object of the invention to provide a bicycle chain protector capable of protecting front and rear derailleurs.

It is an additional object of the invention to provide a chain and derailleurs protector having a pouch-like enclosure, a central flap which is folded over the top center of a bicycle chain once the pouch is in place over front and rear sprockets, Velcro (hook and loop) patches securing portions of the cover about the front and rear sprockets, a zipper to secure the flap in place, and a cinch enclosure with a barrel lock about the seat post and above the front bicycle sprocket and derailleurs to stop water and debris from migration down the post and onto the bicycle drive train.

It is yet another object of the invention to provide a protective cover in the form a pouch for the sprocket wheels and chainstay of a tandem bicycle.

It is a further object of the invention to provide a protective cover for a tandem bicycle as above having adjustable straps movable across the cover to the desirable location relative to the tandem bicycle frame capable of being tightened around the frame and chain.

It is an object of the invention to provide improved elements and arrangements thereof in an improved, flexible, bicycle drive train cover for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front elevational view of the invention as it would appear on a bicycle drive train, a zipper flap protector being lifted to show the underlying zipper.

FIG. 2 is a rear elevational view of the invention, removed from a bicycle.

FIG. 3 is a view similar to FIG. 2, but with a central flap opened to better show interior construction details.

FIG. 4 is an enlarged view of the seat post cinch-tied enclosure with a barrel lock.

FIG. 5 is a side elevation view of an additional cover for the chainstay installed on a tandem bicycle.

FIG. 6 is a back side elevation view of the cover of FIG. 5.

FIG. 7 is a side elevation view of the additional cover as above in FIG. 6 as installed in an open position.

FIG. 8 is a detail view of the slidably mounted cover straps of FIG. 5.

Similar reference characters denote corresponding features consistently throughout the attached drawings.

### DETAILED DESCRIPTION OF THE PREFERRED EMBODIMENTS

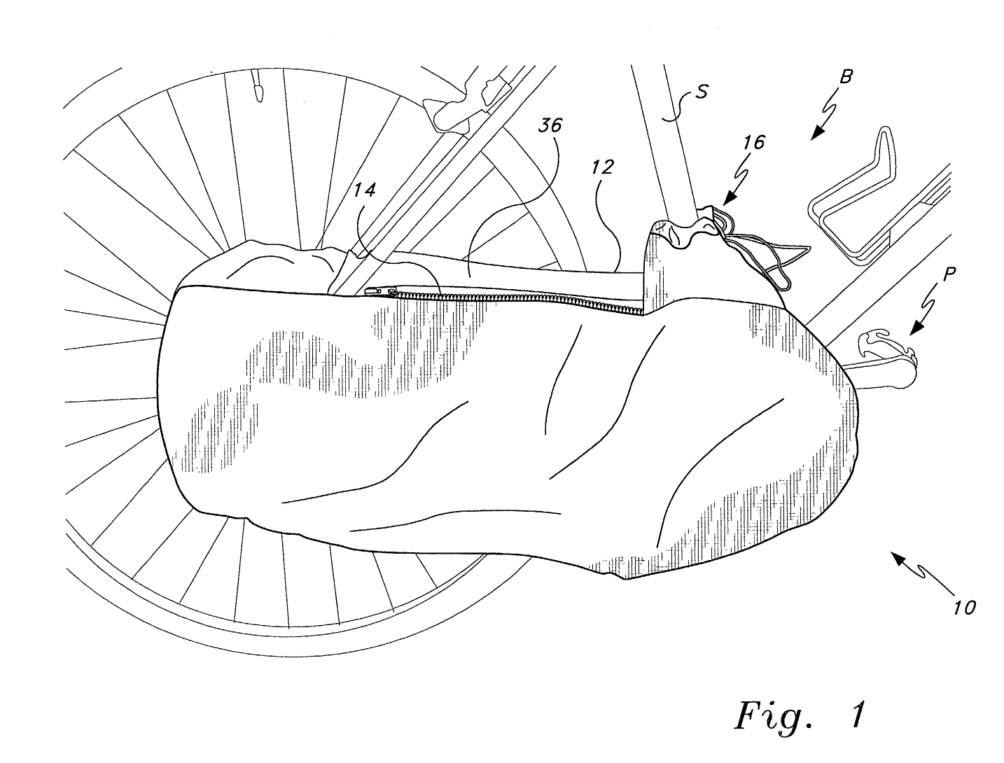

Referring now to the drawings, by reference character, and in particular, FIG. 1 thereof, the invention is shown as including a cover in the form of an elongated pouch 10 which is dimensioned and configured to encase the drive train of a bicycle. The drive train includes at least the front and rear sprockets and derailleurs, chain, and one pedal of a bicycle B. The other pedal P remains exposed. The other major components of the invention include a single flap 12, secured in place with a zipper assembly 14, and a cinch-tied enclosure 16 surrounding the base of seat post S of the bicycle. The function of enclosure 16 is to keep water and debris from migrating down the seat post and into the drive train components inside the invention cover.

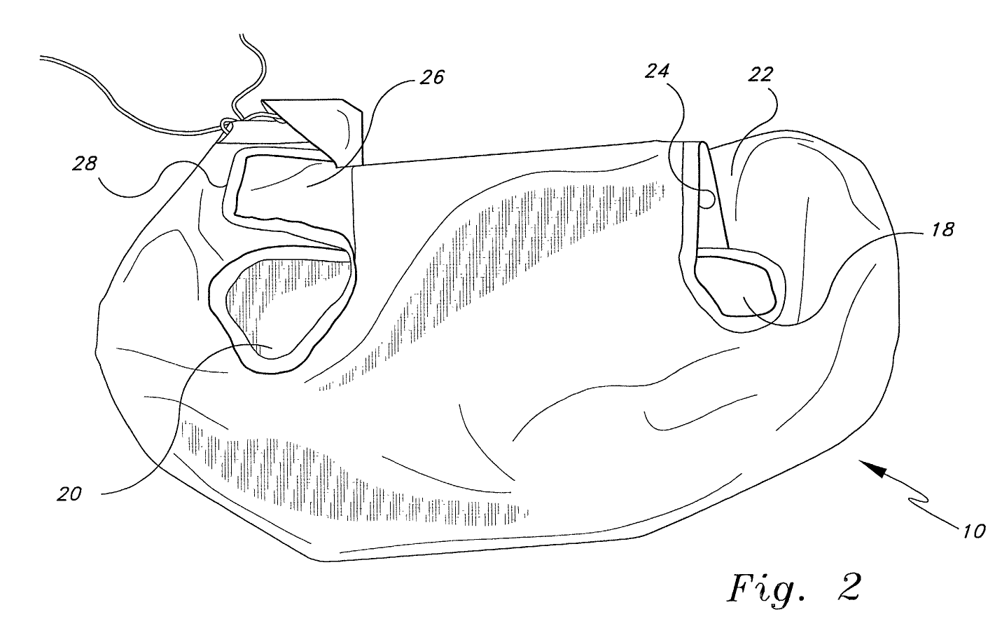

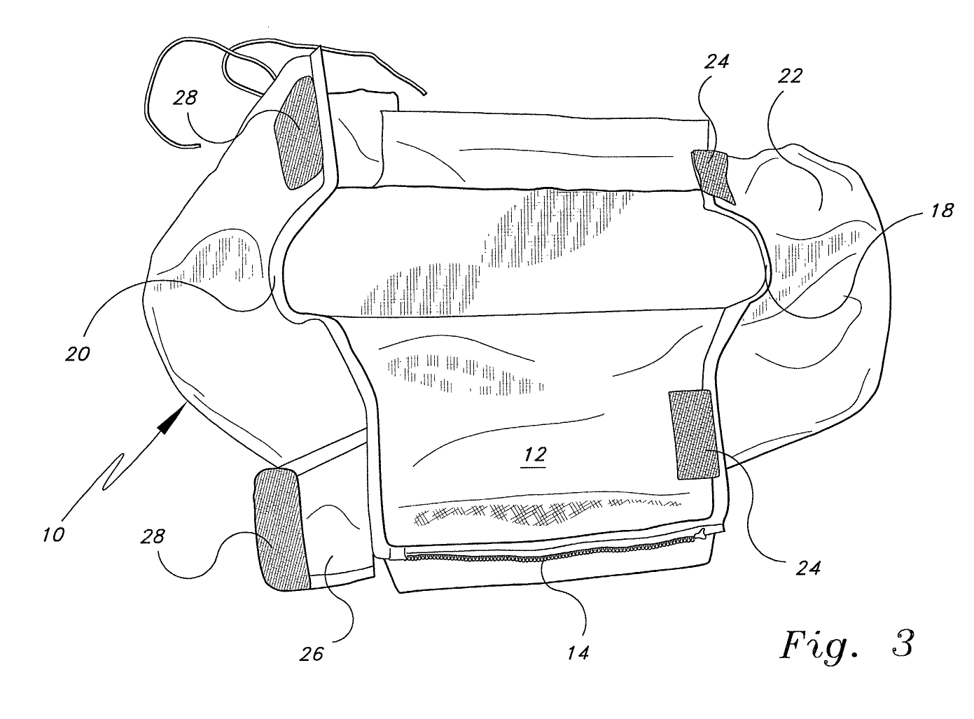

Turning now to FIG. 2, the major portion of flap 12 is shown which, with the cover in place, defines a first, rear hole 18, for the rear wheel axle of the bicycle, and a second, front hole 20 for the pedal crank axle of the exposed pedal P. With consideration of FIGS. 2 and 3 together, there is shown a first, forwardly extending tongue 22 on the top, rear opening covered by flap 12 which, together with tongue 22, is shaped to define rear axle hole 18. Velcro (hook and loop) patches 24 attach tongue 22 to a rear edge of flap 12. Similarly, flap 12 includes a forwardly extending tongue 26 secured to pouch 10 with Velcro (hook and loop) patches 28, the cooperating tongue and flap configured, to define second hole 20 for the exposed pedal P crank axle.

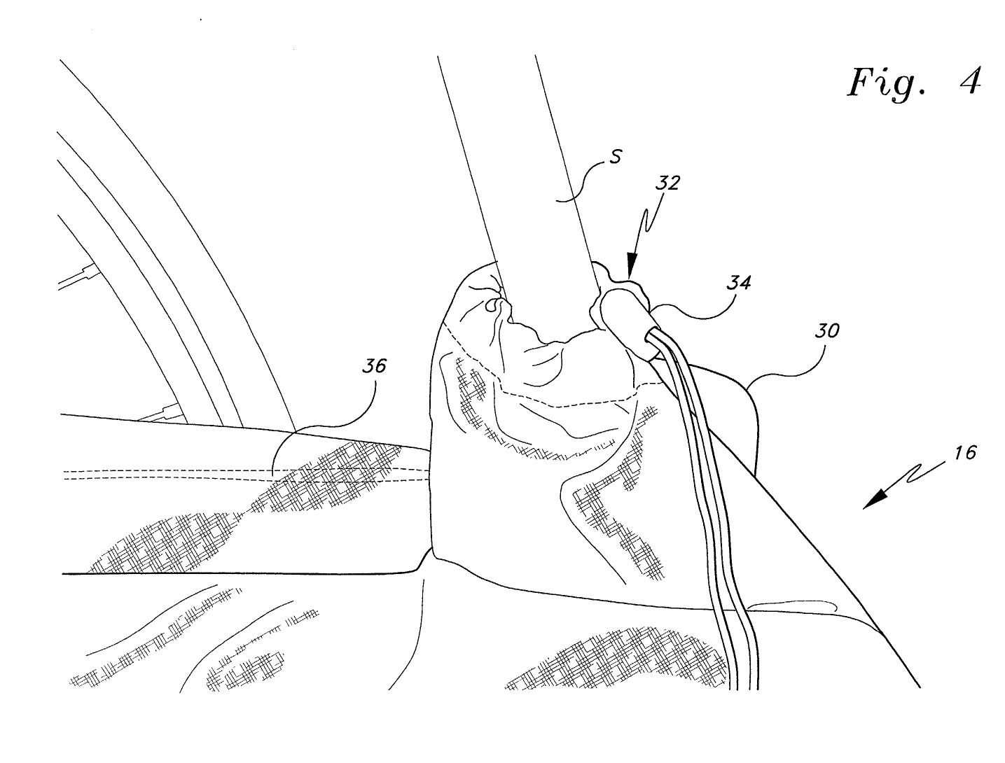

Considering FIG. 4, seat post cinch-tied enclosure 16 is shown in greater detail. Approximately half of enclosure 16 is sewn to the major body of the cover, and the other half forms a cinch-tied flap 30, secured in place with the cinch tie 32, which may include an otherwise conventional, slide barrel lock 34. Also seen in this view is a weather flap 36 which overlays zipper assembly 14.

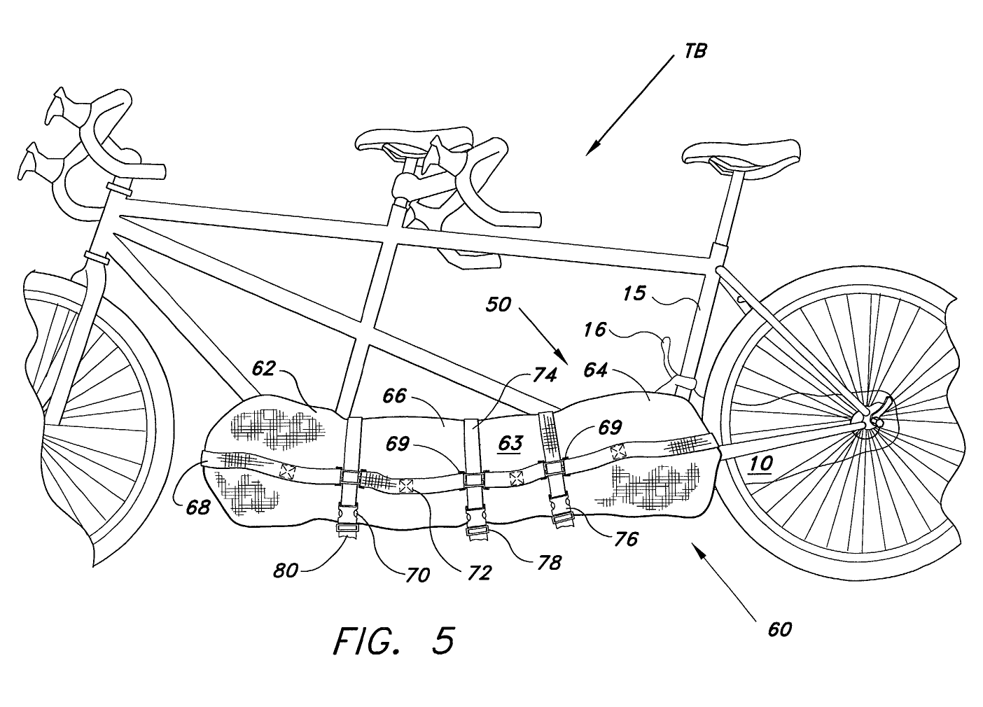

Referring to FIG. 5, tandem bicycle chain and derailleur cover system 50 includes removable bicycle cover 10 and tandem bicycle chainstay cover 60 for tandem bicycle TD.

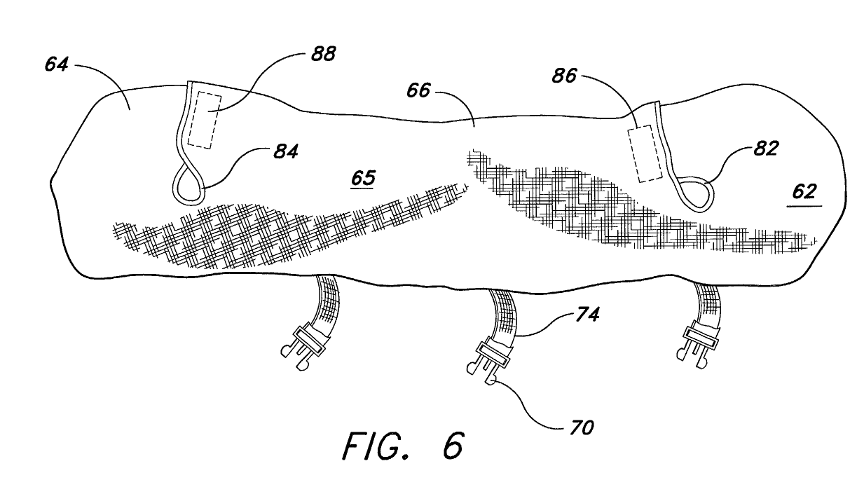

Tandem bicycle chainstay cover 60 is a generally elongated pouch for installation along the frame of tandem bicycle TB and includes a tandem cover front portion 62, tandem cover rear portion 64, and tandem cover central portion 66. The sum of the front portion 62, rear portion 64, and central portion 66 define an outer-facing or front side 63 and an inner-facing portion or backside 65 (see FIG. 6) facing the tandem bicycle frame TB. Tandem cover 60 features a peripheral strap 68 encircling it along the length of the pouch-like cover. A plurality of peripheral strap sliding belt buckles 69 connect cross over straps 74 with peripheral strap 68. Cross over straps 74 wrap around the tandem cover 60 crosswise of peripheral strap 68 and attach by cross strap lower buckle portions 70 being inserted into their respective cross strap upper buckle portions 76. Peripheral belt 68 is sewn to tandem cover 60 by stitching points 72. Cross over straps 74 have length-adjusting buckles 78 leaving strap free ends 80 upon strap length adjustment.

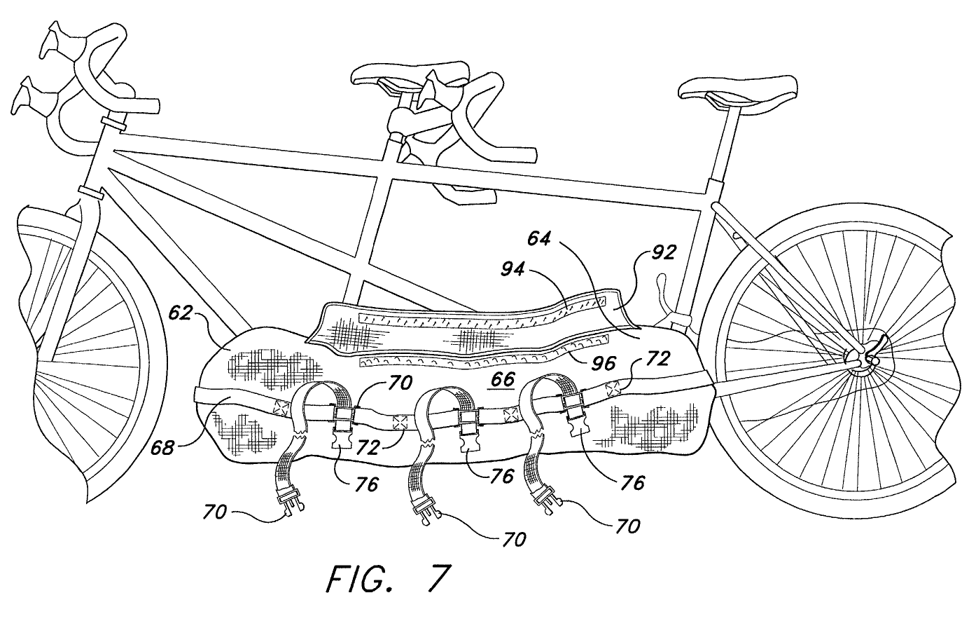

Referring to FIG. 6, there is shown an elevation view of the inner-face or back side portion 63 of tandem cover 60 having front portion 62, rear portion 64, and central portion 66. Chain stay cover front pedal crank opening 82 and chain stay cover rear or aft pedal crank opening 84 are formed by folding over the chain stay cover lengthwise flap 92 (see FIG. 7) and fastened by hook and loop front attachment 86 and hook and loop rear attachment 86. Cross over straps 74 are shown with cross over strap lower buckle portions 70 disconnected from their upper portions 76 (not shown).

Referring to FIG. 7, there is shown a side elevation view of the tandem cover 60 as installed in the open position with chainstay cover lengthwise flap 92 and cross over straps 74 having their respective lower buckle portions 70 and upper buckle portions 76 separated. Chainstay cover lengthwise flap 92 has chain stay cover flap hook strip 94 attached lengthwise along the mouth of flap 92 so as to mate with chainstay cover flap loop strip 96 located along the upper length of tandem cover 60 to allow mounting over the tandem bicycle TB chainstay and then securing flap 92 over the chainstay for maintaining it in a covered condition.

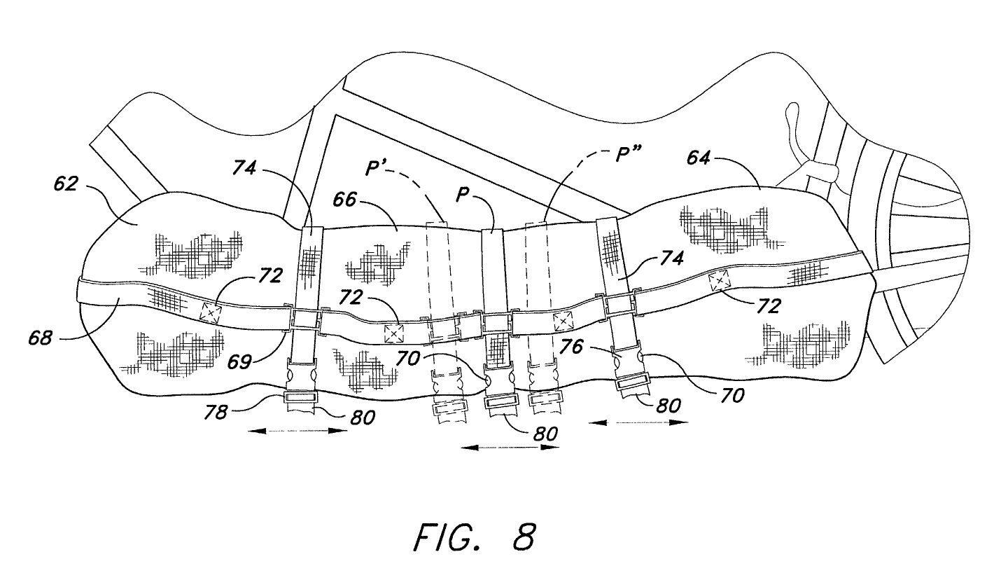

Referring to FIG. 8 there is shown a side elevation view of the inventive tandem bicycle chain stay cover similar to that of FIG. 5, illustrating the adjustability of cross over belts 74. The cross over belts may be moved forward or aft from the central position P within the respective loops formed between the peripheral 68 and the stitching points 72. The cross over straps 74 are slidingly connected to peripheral strap 68 by peripheral strap sliding belt buckles 69, allowing cross straps 74 to move forward to the P′ position or move back to the P″ position.

Placing the invention about the bicycle drive train is demonstrably uncomplicated. As can be appreciated from an inspection of FIG. 3, the opening defined by flap 12 coupled with the inherent flexibility of the cover allows the open cover to be slipped easily onto the drive train from beneath. Flap 12 may be brought up and over the central part of the bicycle chain and zipped at 14. It has been found that the zipper cover flap 36 will lay in place over the zipper assembly without need of any further securement to keep it in place. Tongues 22 and 26 will be so located that the Velcro patches are properly secured with a simple hand motion. The cinch-tied enclosure 16 is then brought about seat post base S and locked in place with the barrel lock 34.

For a tandem bicycle TD, tandem bicycle chainstay cover 60 is placed over the chainstay by opening cross strap buckles 70,76 and opening lengthwise cover flap 92. The cover 60 is then placed over the front sprocket, the rear or aft sprocket and the intervening chain of the chainstay drivetrain and flap 92 is secured with hook strip 94 and loop strip 96. Cross over straps 74 are adjusted along the length of the frame of tandem bicycle TD to convenient positions and cross over straps 74 are closed around the tandem bicycle frame and chainstay cover 60 by means of closing buckles 70,76 and pulling strap free end 80 through cross over strap length adjustment buckle 78 until taut.

The material making up the invention may be selected from any one of a wide variety of woven or non-woven, synthetic and even non-synthetic materials well known to those skilled in the art. The material may be weather and/or water proof. The exterior of the cover may be attractively colored or have any pleasing design and/or advertising.

It is to be understood that the present invention is not limited to the embodiments described above, but encompasses any and all embodiments within the scope of the following claims.

I claim:

1. A removable, flexible cover for the drive train of a bicycle, said cover comprising:
a) an elongated flexible pouch dimensioned and configured for completely encasing the front and rear sprockets, the derailleurs, the drive chain and one foot pedal of a bicycle, the pouch having a central top opening formed in said pouch and sized to fit over the drive train of a bicycle;
b) a single flap foldable over the portion of the drive train extending between the sprockets, said flap being integral with said pouch; and
c) closure means along said pouch for releasably closing said flap over the central top opening defined in said pouch.

2. The removable, flexible cover according to claim 1, wherein said pouch further comprises:
a) a first tongue extending forwardly adjacent a top rear end of said opening and having a free end releasably attached to said flap, said first tongue and said flap defining a rear opening sized and dimensioned for a rear axle of the bicycle to pass through when the free end of said first tongue is attached to said pouch and said flap is closed over the central top opening; and
b) a second tongue extending forwardly from said flap and having a free end releasably attached to said pouch, said second tongue and said flap defining a front opening dimensioned and configured for passing a pedal crank of the bicycle through the front opening when the free end of said second tongue is attached to said pouch and said flap is closed over said central top opening.

3. The removable, flexible cover according to claim 2, further comprising:
a first cooperating pair of hook and loop patches attached to said first tongue and to said flap for attaching said flap to said first tongue; and
a second cooperating pair of hook and loop patches attached to said second tongue and to said pouch for attaching said second tongue to said pouch.

4. The removable, flexible cover according to claim 1, further comprising a cinch-tied enclosure disposed at a top forward end of said pouch, the cinch-tied enclosure being configured to encircle the seat post of a bicycle and being cinched for preventing water and dirt from migrating inside said cover and onto the bicycle drive train.

5. The device according to claim 1, wherein said closure means comprises a zipper assembly at least partly disposed on said flap.

6. The device according to claim 5, wherein said pouch further comprises a protective flap covering said zipper assembly.

7. A system for covering the drive train of a tandem bicycle comprising:
a) a removable, flexible cover for the rear drive train of said tandem bicycle, said cover comprising:
i) an elongated flexible pouch dimensioned and configured for completely encasing the front and rear sprockets, the derailleurs, the drive chain and one foot pedal of a bicycle, the pouch having a central top opening formed in said pouch and sized to fit over the drive train of a bicycle;
ii) a single flap foldable over the portion of the drive train extending between the sprockets, said flap being integral with said pouch; and
iii) closure means along said pouch for releasably closing said flap over the central top opening defined in said pouch; and
b) a removable, flexible cover for the chainstay drive train of said tandem bicycle, said chainstay having front and rear sprockets and a chain, said cover comprising:
i) an elongated flexible pouch dimensioned and configured for completely encasing the chainstay, one front foot pedal, and one corresponding back pedal of a said tandem bicycle, the pouch having a central top opening formed in said pouch and sized to fit over the chainstay drive train of said tandem bicycle;
ii) a single flap foldable over the portion of the drive train extending between said sprockets of said chainstay, said flap being integral with said pouch; and
iii) closure means along said pouch for releasably closing said flap over said central top opening defined in said pouch.

8. The removable, flexible cover for the rear drive train of said tandem bicycle according to claim 7, wherein said pouch further comprises:
a) a first tongue extending forwardly adjacent a top rear end of said opening and having a free end releasably attached to said flap, said first tongue and said flap defining a rear opening sized and dimensioned for a rear axle of said tandem bicycle to pass through when said free end of said first tongue is attached to said pouch and said flap is closed over said central top opening; and
b) a second tongue extending forwardly from said flap and having a free end releasably attached to said pouch, said second tongue and said flap defining a front opening dimensioned and configured for passing a rear pedal crank of said tandem bicycle through the front opening when the free end of said second tongue is attached to said pouch and said flap is closed over said central top opening.

9. The removable, flexible cover according to claim 8, further comprising:
a) a first cooperating pair of hook and loop patches attached to said first tongue and to said flap for attaching said flap to said first tongue; and
b) a second cooperating pair of hook and loop patches attached to said second tongue and to said pouch for attaching said second tongue to said pouch.

10. The removable, flexible cover according to claim 7, further comprising a cinch-tied enclosure disposed at a top forward end of said pouch, the cinch-tied enclosure being configured to encircle the rear seat post of said tandem bicycle and being cinched for preventing water and dirt from migrating inside said cover and onto the bicycle drive train.

11. The device according to claim 7, wherein said closure means comprises a zipper assembly at least partly disposed on said flap.

12. The device according to claim 11, wherein said pouch further comprises a protective flap covering said zipper assembly.

13. A removable, flexible cover for the chainstay drive train of a tandem bicycle, said chainstay having front and rear sprockets and a chain therebetween, said cover comprising:
i) an elongated flexible pouch dimensioned and configured for completely encasing the chainstay, one front foot pedal, and one corresponding back or aft pedal of a said tandem bicycle, the pouch having a central top opening formed in said pouch and sized to fit over the chainstay drive train of said tandem bicycle;
ii) a single flap foldable over the portion of the said drive train extending between said sprockets of said chainstay, said flap being integral with said pouch; and
iii) closure means along said pouch for releasably closing said flap over said central top opening defined in said pouch.

14. The tandem bicycle chainstay drive train cover of claim 13, wherein said elongated pouch has a front end portion, an aft end portion, and a central portion, and an outer-facing portion for facing outward from said tandem bicycle, and an inner-facing backside portion for facing the frame of said tandem bicycle, each defined by said front end portion, said aft portion, and said central portion, respectively, said front end portion being configured to cover a front sprocket, said aft end portion being configured to cover an aft sprocket, and said central portion being configured to cover said chain.

15. The tandem bicycle chainstay drive train cover of claim 14, wherein said flap forms front and rear apertures along said inner-facing portion for receiving respective front and aft pedal cranks, and wherein said front and rear apertures are formed between respective front and rear portions of said flap and said front and aft portions of said elongated pouch, and closed by respective front and aft hook and loop portions located in respective overlaps between said flap and said elongated pouch.

16. The tandem bicycle chainstay drive train cover of claim 15, wherein said closure means for said opening comprises mating hook and loop strips along the length of said flap and said elongated pouch, respectively.

17. The tandem bicycle chainstay drive train cover of claim 14, further comprising a peripheral strap surrounding said elongated pouch lengthwise and a plurality of cross over straps surrounding said elongated pouch located crosswise and distributed along the length of said elongated pouch.

18. The tandem bicycle chainstay drive train cover of claim 17, further comprising a peripheral strap sliding buckle located at each intersection of each cross over strap with said peripheral strap along said pouch outer-facing portion.

19. The tandem bicycle chainstay drive train cover of claim 18, further comprising a plurality of sewn peripheral strap-to-bag attachments so spaced along said peripheral strap so located as to isolate each said cross strap at a location along said pouch outer-facing portion so as to allow each said cross over strap to be moved for a limited distance along said peripheral strap and thereby allow adjustment of said cross over straps to conveniently fit over the frame portion of said tandem bicycle along said pouch inner-facing portion.

20. The tandem bicycle chainstay drive train cover of claim 19, further comprising cross strap length adjustment buckle located on each of said cross over straps for tightening said cross over straps around said pouch and said tandem bicycle frame after installation of said pouch over said chainstay drive train, closing said flap, over said front and aft foot pedal cranks, engaging said cross over strap lower buckle portion and said cross over strap upper buckle portion, and adjusting the location of said cross over straps to convenient locations along the frame of said tandem bicycle frame.
